(19) United States
(12) Patent Application Publication
(10) Pub. No.: US 2013/0027649 A1
(43) Pub. Date: Jan. 31, 2013

(54) LIQUID CRYSTAL DISPLAY DEVICE

(71) Applicants: Yasutoshi Tasaka, Osaka-shi (JP); Keiichi Ina, Osaka-shi (JP); Kaori Saitoh, Osaka-shi (JP)

(72) Inventors: Yasutoshi Tasaka, Osaka-shi (JP); Keiichi Ina, Osaka-shi (JP); Kaori Saitoh, Osaka-shi (JP)

(73) Assignee: SHARP KABUSHIKI KAISHA, Osaka-shi, Osaka (JP)

(21) Appl. No.: 13/640,268

(22) PCT Filed: Apr. 6, 2011
(86) PCT No.: PCT/JP2011/058741

§ 371 Date: Oct. 9, 2012

(30) Foreign Application Priority Data
Apr. 12, 2010 (JP) 2010-091663

(51) Int. Cl. G02F 1/1343

(52) U.S. Cl. 349/139

(57) ABSTRACT

Each pixel includes: a pixel electrode (1) which is rectangular and a counter electrode (2) which has an opening (5a), the pixel electrode (1) and the counter electrode (2) being provided so as to face each other; and a liquid crystal layer which is provided between the pixel electrode (1) and the counter electrode(2), in plan view, a distance being not less than 10 μm and not more than 30 μm between each of short sides of the pixel electrode (1) and the opening (5a).

### TECHNICAL FIELD

The present invention relates to a liquid crystal display device, particularly to a vertically aligned liquid crystal display device in which liquid crystal molecules are vertically aligned during no voltage application.

### BACKGROUND ART

A TN (Twisted Nematic) liquid crystal display device has been widely used as a liquid crystal display device. The TN liquid crystal display device is arranged as below. In a case where a liquid crystal layer is formed by rubbing two upper and lower alignment films in different directions, liquid crystal molecules are twisted (in a state of twist alignment) in a state of no voltage application.

However, in the TN liquid crystal display device, it is necessary to carry out an antistatic treatment for preventing an influence of static electricity which is produced during a rubbing process. This causes a problem of an increase in number of processes to be carried out. The TN liquid crystal display device also causes a problem such that a display quality has a high viewing angle dependence.

Meanwhile, a VA (Vertically Aligned) liquid crystal display device is used as a liquid crystal display device that has a wide viewing angle characteristic. The VA liquid crystal display device includes a liquid crystal material having negative dielectric anisotropy and vertical alignment films. According to the VA liquid crystal display device, liquid crystal molecules are in a vertical state (a state of vertical alignment) in a state of no voltage application.

According to the VA (vertically aligned) liquid crystal display device, liquid crystal molecules in a liquid crystal layer stands in a vertical direction in a state of no voltage application. Therefore, light emitted from the liquid crystal layer contains only a linearly polarized light component, and the light is perfectly cut by a polarization plate, so that the light is not transmitted through the liquid crystal display device. A voltage application causes generation of an electric field between electrodes which are provided so as to face each other. In response to the generation of the electric field, the liquid crystal molecules in the liquid crystal layer tilt. This causes light emitted from the liquid crystal layer to contain a linearly polarized light component and an elliptically polarized light component. Accordingly, light which is not cut by the polarization plate and contains an elliptically polarized light component is transmitted through the liquid crystal display device.

However, the vertically aligned liquid crystal display device has a problem such that for example, ununiformity in direction in which liquid crystal molecules are aligned (i) causes, in each pixel, disclination which varies in shape and location in the each pixel and (ii) causes roughness of an image.

In order to solve the problems, each of Patent Literatures 1 and 2 proposes an arrangement in which alignment control means is provided in a liquid crystal display device.

FIG. 5 is a perspective view showing how electrodes are provided in a liquid crystal display device described in Patent Literature 1.

The liquid crystal display device described in Patent Literature 1 includes a liquid crystal layer 112 containing liquid crystal molecules which are vertically aligned between (i) a plurality of pixel electrodes 111 separately provided for each pixel and (ii) counter electrodes 113 facing the plurality of pixel electrodes 111 (see FIG. 5). An opening 114 is provided for the counter electrodes 113. The opening 114 is provided only in a region of the counter electrodes 113 which region faces a substantially central region of the plurality of pixel electrodes 111.

No counter electrode 113 exists in the region in which the opening 114 is provided. Therefore, an electric field generated between the plurality of pixel electrodes 111 and the counter electrodes 113 is weak in the region in which the opening 114 is provided, and the liquid crystal molecules contained in the liquid crystal layer 112 and existing in the region in which the opening 114 is provided are hardly influenced by the electric field generated between the plurality of pixel electrodes 111 and the counter electrodes 113. This enables the liquid crystal molecules in this region to maintain an original state of vertical alignment and to stably stand in a vertical direction. In addition, the liquid crystal molecules existing in a vicinity of the region in which the opening 114 is provided are also stable in alignment by an interaction with the liquid crystal molecules existing in the region in which the opening 114 is provided. This causes the liquid crystal molecules in each pixel to be aligned in a regular direction.

In a case where the opening 114 is provided at an identical location of a region in which each pixel is provided, the liquid crystal molecules are similarly aligned in all the pixels. Therefore, even if directions in which the liquid crystal molecules are aligned vary slightly among the pixels, a disclination line indicative of a boundary between the directions in which the liquid crystal molecules are aligned appears uniformly in a substantially identical part in each pixel. This makes it possible to prevent roughness of an image.

FIG. 6 is a plan view showing how electrodes are provided in a liquid crystal display device described in Patent Literature 2.

According to the liquid crystal display device described in Patent Literature 2, one set of electrodes 201 and the other set of electrodes 202 are provided so as to be orthogonal to each other. The one set of electrodes 201 is provided with an opening 203 which is substantially parallel to an end of the other set of electrodes 202. The opening 203 roughly divides an electrode intersection 205 of the one set of electrodes 201 and the other set of electrodes 202 into two main regions. In a case where an electric field is tilted in a given direction in those main regions, a homogeneous display can be obtained.

An arrangement is also known in which a protruding rivet part is provided, as alignment control means of a liquid crystal display device, for a surface of a counter electrode which surface faces a pixel electrode.

### CITATION LIST

### Patent Literatures

Patent Literature 1

Japanese Patent Application Publication, Tokukai, No. 2002-31820 (Publication Date: Jan. 31, 2002)

Patent Literature 2

Japanese Patent Application Publication, Tokukaihei, No. 3-259121 (Publication Date: Nov. 19, 1991)

### SUMMARY OF INVENTION

### Technical Problem

However, according to the arrangement described in Patent Literature 1, in a case where a pixel is rectangular, a distance between a short side A of the pixel and the opening 114 is long in plan view, and thus alignment is less controlled (see FIG. 7). As a result, liquid crystal molecules are randomly aligned due to switching of display screens and/or pressing. This causes roughness of an image and/or an afterimage, so that a problem of a deterioration in display quality occurs. Note here that FIG. 7 is a plan view showing one (1) pixel of the liquid crystal display device in accordance with Patent Literature 1.

According to the arrangement described in Patent Literature 2, in a case where a pixel is rectangular, a region is narrow in which liquid crystal molecules tilt in a long side B direction of the pixel (see FIG. 8). This causes a problem of a deterioration in viewing angle characteristic in a vertical direction. Note that FIG. 8 is a plan view showing one (1) pixel of the liquid crystal display device in accordance with Patent Literature 2.

Provision of a protruding rivet part, as alignment control means of a liquid crystal display device, for a surface of a counter electrode which surface faces a pixel electrode causes a problem of a deterioration in contrast and display quality.

The present invention has been made in view of the problems, and an object of the present invention is to provide a liquid crystal display device which is excellent in viewing angle characteristic and display quality.

### Solution to Problem

In order to attain the object, a liquid crystal display device of the present invention includes: a plurality of pixels provided in a matrix pattern, the plurality of pixels each including: a pixel electrode which is rectangular and a counter electrode which has an opening, the pixel electrode and the counter electrode being provided so as to face each other; and a liquid crystal layer which is provided between the pixel electrode and the counter electrode, in plan view, a distance being not less than 10 μm and not more than 30 μm between each of short sides of the pixel electrode and the opening.

According to the arrangement, since the distance between each of the short sides of the pixel electrode and the opening is not less than 10 μm in plan view, a region is enlarged in which liquid crystal molecules tilt in a long side direction of a pixel, so that a viewing angle characteristic in a vertical direction can be enhanced.

Further, since the distance between each of the short sides of the pixel electrode and the opening is not more than 30 μm in plan view, an alignment control force increases, and random alignment of the liquid crystal molecules due to switching of display screens and/or pressing is restored. This allows enhancement of a display quality while preventing occurrence of roughness of an image and/or an afterimage.

### Advantageous Effects of Invention

A liquid crystal display device of the present invention includes: a plurality of pixels provided in a matrix pattern, the plurality of pixels each including: a pixel electrode and a counter electrode which are provided so as to face each other; and a liquid crystal layer which is provided between the pixel electrode and the counter electrode, the counter electrode having an opening, the pixel electrode being rectangular, and in plan view, a distance being not less than 10 μm and not more than 30 μm between each of short sides of the pixel electrode and the opening.

Therefore, it is possible to provide a liquid crystal display device which is excellent in viewing angle characteristic and display quality.

### BRIEF DESCRIPTION OF DRAWINGS

FIG. 1 is a plan view showing how electrodes are provided in a liquid crystal display device in accordance with an embodiment of the present invention.

FIG. 2 is a perspective view showing an arrangement of relevant parts of the liquid crystal display device in accordance with the embodiment of the present invention.

FIG. 3 is a cross-sectional view showing an arrangement of relevant parts of the liquid crystal display device in accordance with the embodiment of the present invention.

FIG. 4 is a plan view showing an operation effect of the liquid crystal display device in accordance with the embodiment of the present invention.

FIG. 5 is a perspective view showing how electrodes are provided in a liquid crystal display device in accordance with Patent Literature 1.

FIG. 6 is a plan view showing how electrodes are provided in a liquid crystal display device in accordance with Patent Literature 2.

FIG. 7 is a plan view showing one (1) pixel of the liquid crystal display device in accordance with Patent Literature 1.

FIG. 8 is a plan view showing one (1) pixel of the liquid crystal display device in accordance with Patent Literature 2.

### DESCRIPTION OF EMBODIMENTS

The following description specifically discusses an embodiment of the present invention.

### Embodiment

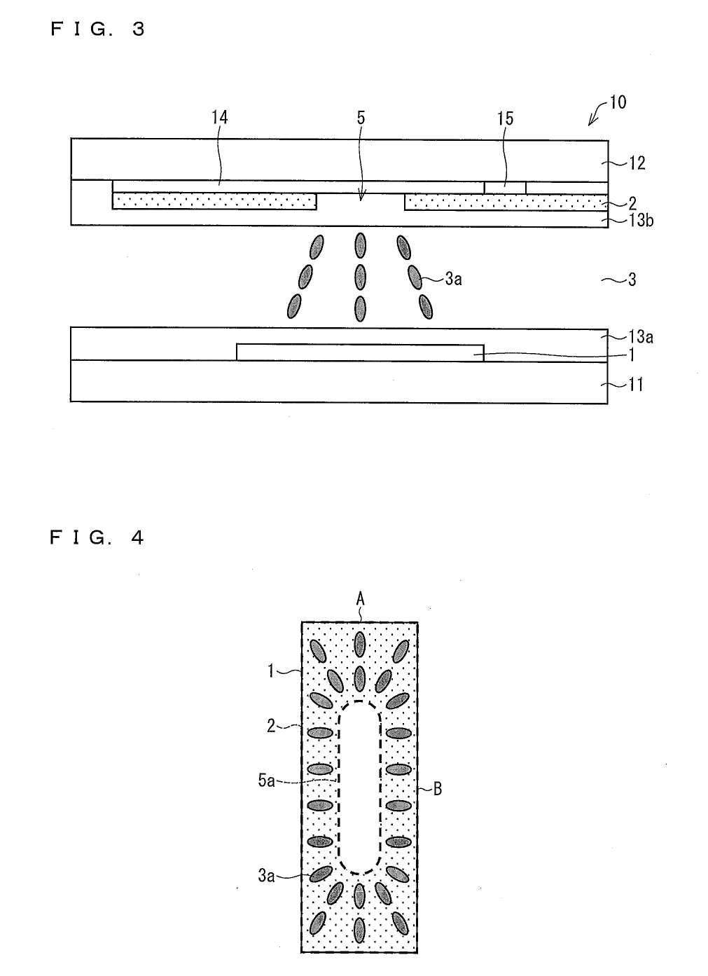

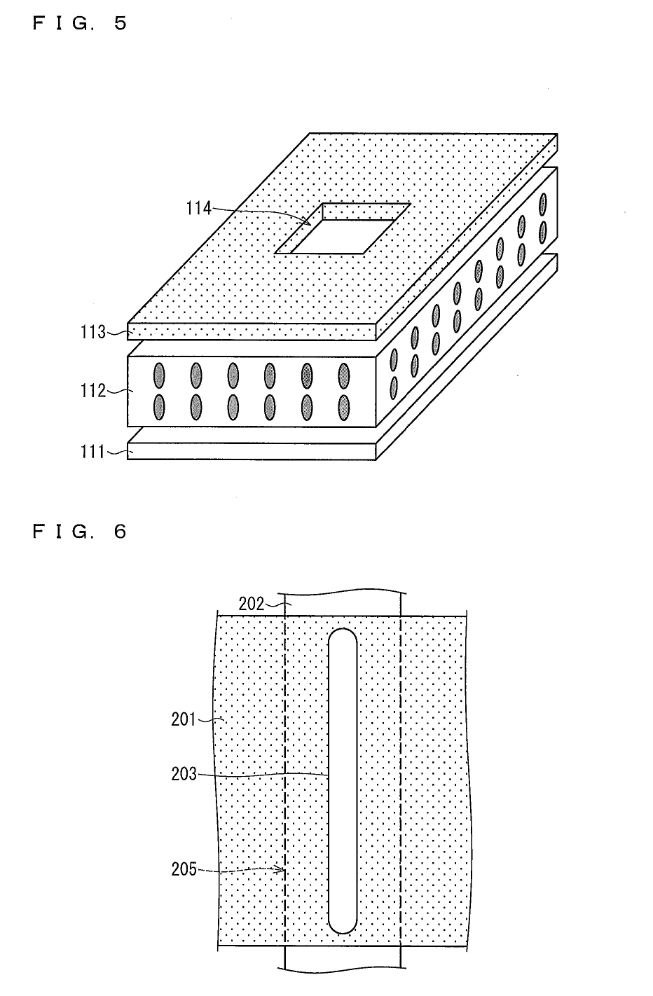

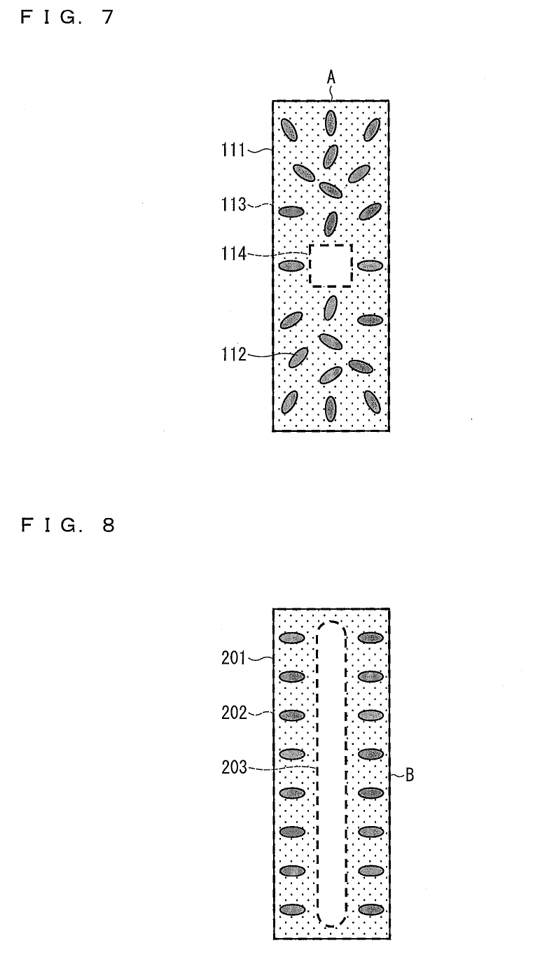

First, a liquid crystal display device in accordance with an embodiment of the present invention is described with reference to FIGS. 2 through 3. FIG. 2 is a perspective view showing an arrangement of relevant parts of the liquid crystal display device in accordance with the embodiment of the present invention. FIG. 3 is a cross-sectional view showing an arrangement of relevant parts of the liquid crystal display device in accordance with the embodiment of the present invention.

According to a liquid crystal display device 10, a plurality of pixels are provided in a matrix pattern, and each of the plurality of pixels includes a liquid crystal layer 3 which is made of a nematic liquid crystal material having negative dielectric anisotropy, and a pixel electrode 1 and a counter electrode 2 which face each other via the liquid crystal layer 3 (see FIG. 2).

The counter electrode 2 has an opening 5, and one (1) opening 5a is provided for each of the plurality of pixels. Note that counter electrodes 2 except their respective openings 5 are provided continuously in all of the plurality of pixels.

The following description specifically discusses, with reference to FIG. 3, an arrangement of relevant parts of the liquid crystal display device in accordance with the present embodiment.

The liquid crystal display device 10 includes a TFT (Thin Film Transistor) side transparent substrate 11 such as a glass substrate or the like, a counter electrode side transparent substrate 12 which is provided so as to face the TFT side transparent substrate 11, and the liquid crystal layer 3 which is provided between the TFT side transparent substrate 11 and the counter electrode side transparent substrate 12 and is a vertically aligned liquid crystal layer (see FIG. 3).

The pixel electrode 1 is provided on the TFT side transparent substrate 11, and the counter electrode 2 is provided on the counter electrode side transparent substrate 12. Then, a pixel is constituted by the liquid crystal layer 3 which is provided between the pixel electrode 1 and the counter electrode 2. According to the present embodiment, each of the pixel electrode 1 and the counter electrode 2 is a transparent conductive layer which is made of a material such as ITO (Indium Tin Oxide) or IZO (Indium Zinc Oxide).

Vertical alignment films 13a and 13b are provided on respective surfaces of the pixel electrode 1 and the counter electrode 2, the surfaces each being in contact with the liquid crystal layer 3. Liquid crystal molecules 3a in the liquid crystal layer 3 are aligned in a substantially vertical direction with respect to respective surfaces of the vertical alignment films 13a and 13b during no voltage application. That is, the liquid crystal display device 10 is a vertically aligned liquid crystal display device, and the liquid crystal layer 3 contains a nematic liquid crystal material having negative dielectric anisotropy.

A color filter 14 which corresponds to each of the plurality of pixels and a black matrix (light blocking layer) 15 which is located between respective adjacent color filters 14 are provided on the liquid crystal layer 3 side of the counter electrode side transparent substrate 12. The counter electrode 2 is provided on the color filter 14 and the black matrix 15. Note, however, that how to provide the color filter 14 and the black matrix 15 is not limited to this. The color filter 14 and the black matrix 15 may be provided on the liquid crystal layer 3 side of the counter electrode 2.

A plurality of gate lines (not shown) and a plurality of source lines (not shown) are provided on the TFT side transparent substrate 11. The plurality of source lines are provided orthogonally to the plurality of gate lines. In a vicinity of each of intersections of the plurality of gate lines and the plurality of source lines, a TFT element (not shown) is provided as a switching element which is electrically connected to each of a corresponding gate line and a corresponding source line. The pixel electrode 1 is provided so as to correspond to each TFT element in a region surrounded by a pair of adjacent gate lines and a pair of adjacent source lines.

A pair of polarization plates (not shown) is further provided in the liquid crystal display device 10 so as to face each other via the TFT side transparent substrate 11 and the counter electrode side transparent substrate 12. Note that the pair of polarization plates is provided so that their respective transmission axes are orthogonal to each other.

The opening 5 is provided in a part of the counter electrode 2 which part faces the pixel electrode 1. According to the present embodiment, one (1) opening 5a is provided for each pixel.

In a case where the liquid crystal display device 10 is activated and then a voltage is applied to the pixel electrode 1, an electric field is generated between the pixel electrode 1 and the counter electrode 2. Then, an influence of the generation of the electric field causes tilting of the liquid crystal molecules 3a contained in the liquid crystal layer 3 and existing in a region in which the pixel electrode 1 is provided.

In this case, no counter electrode 2 exists in the opening 5. Therefore, an electric field is weak in a region in which the opening 5 is provided. Therefore, the liquid crystal molecules 3a existing in the region in which the opening 5 is provided are hardly influenced by the electric field. This enables the liquid crystal molecules 3a in this region to maintain an original state of vertical alignment and to stably stand in a vertical direction.

Therefore, the liquid crystal molecules 3a existing in a vicinity of the region in which the opening 5 is provided are also stable in alignment by an interaction with the liquid crystal molecules 3a existing in the region in which the opening 5 is provided. Accordingly, the liquid crystal molecules 3a in each of the plurality of pixels are aligned radially from the opening 5.

According to this, in a case where an opening 5a is provided at an identical location of a region in which each of the plurality of pixels is provided, the liquid crystal molecules 3a are similarly aligned in all the pixels. Therefore, even if directions in which the liquid crystal molecules 3a are aligned vary slightly among the pixels, a disclination line indicative of a boundary between the directions in which the liquid crystal molecules 3a are aligned appears uniformly in each of the pixels. This makes it possible to prevent roughness of an image.

In addition, characteristics of an image display, which do not differ so much depending on viewing angle directions, are uniform. This allows enhancement of a viewing angle characteristic.

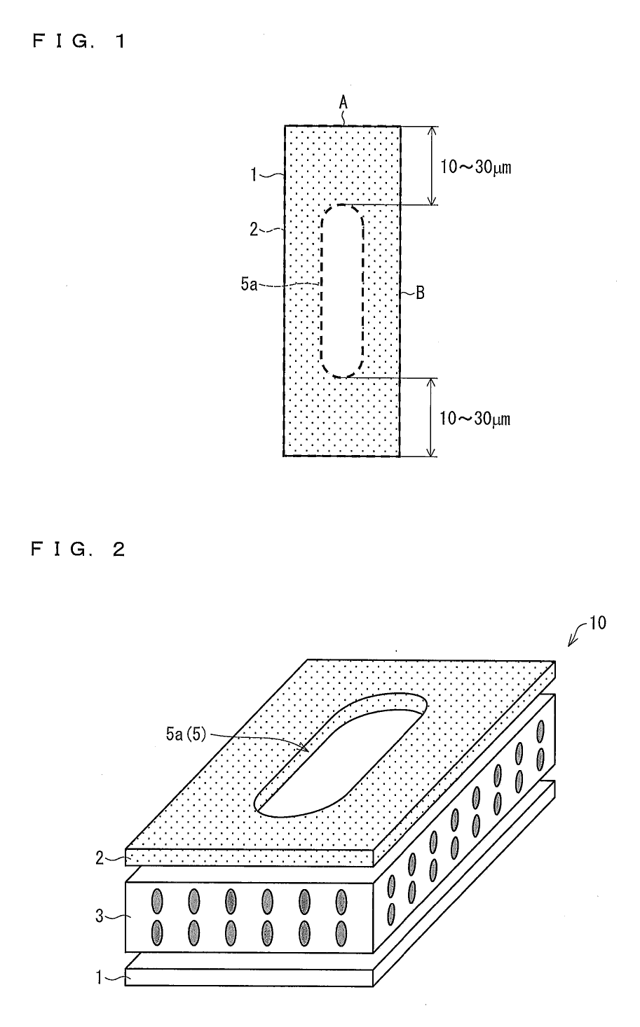

The following description more specifically discusses, with reference to FIG. 1, the opening 5a which is provided for each of the pixels. FIG. 1 is a plan view showing how electrodes are provided in one (1) pixel of the liquid crystal display device in accordance with an embodiment of the present invention.

Each of the pixels includes the pixel electrode 1 and the counter electrode 2 which face each other via the liquid crystal layer 3 (see FIG. 2), and the pixel electrode 1 has a rectangular shape that is 132 μm in length and 44 μm in width (see FIG. 1).

In plan view, the counter electrode 2 has the opening 5a which has a shape surrounded by (i) curved lines which are adjacent to and protrude toward respective short sides A of the pixel electrode 1 and (ii) two straight lines which are parallel to respective long sides B of the pixel electrode 1 and face each other. Note that in plan view, a distance between each of the short sides A of the pixel electrode 1 and the opening 5a is not less than 10 μm and not more than 30 μm.

Note here that, in a case where the distance between each of the short sides A of the pixel electrode 1 and the opening 5a is less than 10 μm in plan view, a region is narrow in which liquid crystal molecules tilt in a long side B direction of a pixel. This causes a problem of a deterioration in viewing angle characteristic in a vertical direction. Note also that, in a case where the distance between each of the short sides A of the pixel electrode 1 and the opening 5a is more than 30 μm in plan view, the distance between each of the short sides A of the pixel and the opening 5a is long in plan view, and thus alignment is less controlled. As a result, liquid crystal molecules are randomly aligned due to switching of display screens and/or pressing. This causes roughness of an image and/or an afterimage, so that a problem of a deterioration in display quality occurs.

In a case where the distance between each of the short sides A of the pixel electrode 1 and the opening 5a is not less than 10 μm and not more than 30 μm in plan view, it is possible to (i) enhance a viewing angle characteristic, (ii) prevent random alignment of liquid crystal molecules due to switching of display screens and/or pressing from causing roughness of an image and/or an afterimage, and (iii) enhance a display quality.

Note that in plan view, the distance between each of the short sides A of the pixel electrode 1 and the opening 5a is more preferably not less than 20 μm and not more than 30 μm, and ideally approximately 25 μm. This allows enhancement of a viewing angle characteristic while securing a maximum transmittance.

Note also that, in a case where the opening 5a which has a shape surrounded by (i) curved lines which are adjacent to and protrude toward respective short sides A of the pixel electrode 1 and (ii) two straight lines which are parallel to respective long sides B of the pixel electrode 1 and face each other is provided in plan view, an alignment control force which is substantially equal omnidirectionally can be exhibited.

Note, however, that the opening 5a is not limited to this and may be rectangular or elliptical. Note here that it is more preferable to provide the opening 5a having curved parts (e.g., the opening 5a having an elliptical shape, or a rectangular shape whose four corners are curved). This is because alignment of liquid crystal molecules can be sequentially changed in the curved parts and thus a viewing angle characteristic can be further enhanced.

FIG. 4 is a plan view showing an operation effect of the liquid crystal display device in accordance with the embodiment of the present invention.

An electric field is generated between the pixel electrode 1 and the counter electrode 2 by a voltage application to the pixel electrode 1, and the liquid crystal molecules 3a in a region in which the pixel electrode 1 is provided are aligned radially from the opening 5a by an influence of the generation of the electric field (see FIG. 4).

Since the distance between each of the short sides A of the pixel electrode 1 and the opening 5a is not less than 10 μm in plan view, a region is enlarged in which the liquid crystal molecules 3a tilt in a long side direction of a pixel, so that a viewing angle characteristic in a vertical direction can be enhanced.

Further, since the distance between each of the short sides A of the pixel electrode 1 and the opening 5a is not more than 30 μm in plan view, an alignment control force increases, and random alignment of the liquid crystal molecules 3a due to switching of display screens and/or pressing is restored. This allows enhancement of a display quality while preventing occurrence of roughness of an image and/or an afterimage.

The present invention is not limited to the description of the embodiments above, but may be altered by a skilled person within the scope of the claims. An embodiment based on a proper combination of technical means disclosed in different embodiments is encompassed in the technical scope of the present invention.

The liquid crystal display device of the present invention is preferably arranged such that in plan view, the distance between each of the short sides of the pixel electrode and the opening is not less than 20 μm.

According to the arrangement, since the distance between each of the short sides of the pixel electrode and the opening is not less than 20 μm, it is possible to enhance a viewing angle characteristic while securing a maximum transmittance.

The liquid crystal display device of the present invention is preferably arranged such that in plan view, the opening has a shape surrounded by (i) curved lines which are adjacent to and protrude toward the respective short sides of the pixel electrode and (ii) two straight lines which are parallel to respective long sides of the pixel electrode and face each other.

The arrangement allows exhibition of an alignment control force which is substantially equal omnidirectionally.

### INDUSTRIAL APPLICABILITY

The present invention is used for liquid crystal display devices such as a mobile phone and a game machine each having a comparatively small pixel pitch.

### REFERENCE SIGNS LIST

1 Pixel electrode

2 Counter electrode

3 Liquid crystal layer

3a Liquid crystal molecule

5-5a Opening

10 Liquid crystal display device

11 TFT side transparent substrate

12 Counter electrode side transparent substrate

13a-13b Vertical alignment film

14 Color filter

15 Black matrix

1. A liquid crystal display device comprising:
a plurality of pixels provided in a matrix pattern,
the plurality of pixels each including:
a pixel electrode which is rectangular and a counter electrode which has an opening, the pixel electrode and the counter electrode being provided so as to face each other; and
a liquid crystal layer which is provided between the pixel electrode and the counter electrode,
in plan view, a distance being not less than 10 μm and not more than 30 μm between each of short sides of the pixel electrode and the opening.

2. The liquid crystal display device as set forth in claim 1, wherein in plan view, the distance between each of the short sides of the pixel electrode and the opening is not less than 20 μm.

3. The liquid crystal display device as set forth in claim 1, wherein in plan view, the opening has a shape surrounded by (i) curved lines which are adjacent to and protrude toward the respective short sides of the pixel electrode and (ii) two straight lines which are parallel to respective long sides of the pixel electrode and face each other.
